(19) United States
(12) Patent Application Publication
(10) Pub. No.: US 2005/0219193 A1
(43) Pub. Date: Oct. 6, 2005

(54) Liquid crystal display

(75) Inventors: Kazutaka Nagaoka, Kumagaya-shi (JP); Shinichi Hirota, Fukaya-shi (JP); Koji Shigehiro, Kumagaya-shi (JP); Toshinori Kanuma, Maebashi-shi (JP); Hiroyoshi Murata, Fukaya-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Toshiba Matsushita Display Technology Co., Ltd., Tokyo (JP)

(21) Appl. No.: 11/088,899

(22) Filed: Mar. 25, 2005

(30) Foreign Application Priority Data
Apr. 2, 2004 (JP) P2004-110279

(51) Int. Cl. G09G 3/36

(52) U.S. Cl. 345/98

(57) ABSTRACT

A liquid crystal display includes a scan line driver (12) to drive scan lines and a power source (14) to supply voltage to the scan line driver. The scan line driver and power source are formed directly on an array substrate of the liquid crystal display. The liquid crystal display also includes a signal-line-driving IC (15) mounted on the array substrate. The IC incorporates a power source (DC voltage converter (1508) and voltage stabilizer (1509)) to supply voltage to a signal line driver (analog output circuit (1504) and the like). The power source in the IC is integrated according to a low-withstanding-voltage manufacturing process. With these configurations, the liquid crystal display is compact and is manufacturable at a low cost.

### CROSS-REFERENCE TO RELATED APPLICATION

This application is based upon and claims the benefit of priority from the prior Japanese Patent Application No. 2004-110279, filed on Apr. 2, 2004. The entire contents of which are incorporated herein by reference.

### BACKGROUND OF THE INVENTION

1. Field of the Invention

The present invention relates to a liquid crystal display having a liquid crystal panel made of glass substrates and liquid crystals held between the glass substrates. In particular, the present invention relates to a liquid crystal display that is small and low in cost.

2. Description of Related Art

Liquid crystal displays having liquid crystal panels are widely used, for example, in cellular phones. The liquid crystal display incorporates integrated circuits to drive the liquid crystal panel.

FIG. 1 is a view showing integrated circuits (ICs) in a liquid crystal display and a manufacturing method thereof according to a related art.

In FIG. 1, a signal-line-driving IC (integrated circuit) incorporates, for example, an analog output circuit that may form a signal line driver to drive signal lines formed on a liquid crystal panel.

The signal-line-driving IC does not need high voltage or negative voltage. Therefore, it does not need to be manufactured according to a coarse design rule for a low cost. Namely, the signal-line-driving IC can be manufactured according to a fine design rule. The signal-line-driving IC may also include an interface for receiving external signals and a timing controller.

On the other hand, a power source IC includes a low-voltage power source and a high-voltage power source. The low-voltage power source generates a low voltage to drive the signal line driver and a scan line driver that drives scan lines of the liquid crystal panel. The high-voltage power source generates a high voltage that is only required by the scan line driver. The power source IC sometimes includes the interface and the like mentioned above. The high-voltage power source also generates a negative voltage used by the scan line driver.

In this way, the power source IC generates high voltage and negative voltage, and therefore, must be manufactured according to a highly-withstandable-voltage process. In addition, to reduce the cost, the power source IC must be manufactured according to a coarse design rule.

The signal-line-driving IC and power source IC are external ICs that are mounted on the liquid crystal panel by, for example, COG (chip on glass).

The signal-line-driving IC and the power source IC are sometimes integrated into one chip to reduce cost. An example of this type of related art is disclosed in Japanese Unexamined Patent Application Publication No. 2001-343945 (Patent Document 1).

FIG. 2 is a view showing a liquid crystal display with a signal-line-driving IC 15A in which a signal-line-driving block and a power source block are integrated according to a related art. A liquid crystal panel 1A consists of a glass array substrate and a counter substrate that are arranged to face each other. Between the array substrate and the counter substrate, a liquid crystal layer is held.

On the array substrate of the liquid crystal panel 1A, scan lines 2 and signal lines 3 are arranged to intersect each other. At each intersection of the scan lines 2 and signal lines 3, a pixel is formed. The scan lines 2, the signal lines 3, and the pixels are in a display area 11. A scan line driver 12 to drive the scan lines 2 and an RGB select switch 13 to properly select signal lines 3 according to display colors (RGB) are directly formed on the array substrate. The signal-line-driving IC 15A is manufactured as an external IC chip according to a highly-withstandable-voltage (for example, 20 V) process and is mounted on the array substrate by COG.

The signal-line-driving IC 15A receives, via FPCs (flexible printed circuits, not shown) connected to the liquid crystal panel 1A, a DC voltage VDD (+2.4 V to +3.3 V), display signals (video signal (RGB signal), synchronizing signal, and clock signal), and a setting signal.

The signal-line-driving IC 15A includes a display signal interface 1501 to receive the display signals, a gamma corrector 1502 to carry out gamma correction, a shift register/latch 1503 to process the display signals, and an analog output circuit 1504 to supply a signal from the shift register/latch 1503 to the RGB select switch 13. The signal-line-driving IC 15A also includes a setting signal interface 1505 to receive the setting signal, a timing controller 1506 to adjust the timing of the setting signal, and a level shifter 1507 to shift the level of a signal from the timing controller 1506 and supply the level-shifted signal to the scan line driver 12. The signal-line-driving IC 15A further includes a DC voltage converter 1508A to convert the DC voltage VDD into a voltage not exceeding +5.5 V, a voltage not exceeding +12 V, and a voltage not below −9 V, a voltage stabilizer 1509A to convert and stabilize the converted voltages into a DC voltage AVDD (+5 V), a DC voltage YGVDD, a DC voltage YGVSS, and a DC voltage XVSS, and a common voltage generator 1510 to drop and stabilize the DC voltage AVDD (+5 V) to a DC common voltage VCOM/VCS.

The liquid crystal display of FIG. 2 integrates a signal-line-driving block and a power source block into one chip, to reduce the cost. The resultant signal-line-driving IC 15A includes the DC voltage converter 1508A and voltage stabilizer 1509A that serve as a power source to generate high voltages and negative voltages. Due to this, the signal-line-driving IC 15A must be manufactured according to a highly-withstandable-voltage process. The circuits that must withstand high voltages, such as the DC voltage converter 1508A and voltage stabilizer 1509A are only a little over 10% of the entire circuits in the IC 15A, and therefore, it is unreasonable to manufacture the IC 15A according to a highly-withstandable-voltage process that increases the cost of the liquid crystal display.

FIG. 3 is a graph showing relationships among the manufacturing process, design rule, and cost of a liquid crystal display. Under the same design rule, an IC manufactured according to a highly-withstandable-voltage process is more costly. If the IC is manufactured according to a fine design rule, the cost thereof further increases. To manufacture a highly-withstandable-voltage IC at a low cost, a coarse design rule must be employed. This, however, increases the size of the IC and thus the size of the liquid crystal display and results in increasing the cost of the liquid crystal display.

### SUMMARY OF THE INVENTION

An object of the present invention is to provide a liquid crystal display that is small and low in cost.

In order to accomplish the object, a first aspect of the present invention provides a liquid crystal display including a liquid crystal panel. The liquid crystal panel consists of two glass substrates facing each other and a liquid crystal layer held between the two glass substrates. One of the two glass substrates includes a display area. The display area includes scan lines, signal lines intersecting the scan lines, and pixels formed at the intersections of the scan lines and the signal lines, respectively. The liquid crystal display is characterized by forming a scan line driver and a first power source directly on the display-area-including glass substrate, the scan line driver driving the scan lines, and the first power source supplying voltage to the scan line driver. The liquid crystal display is also characterized by mounting an IC chip on the display-area-including glass substrate, the IC chip incorporating a second power source integrated in the IC chip according to a low-withstanding-voltage manufacturing process, and the second power source supplying voltage to a signal line driver that drives the signal lines.

The first aspect forms the scan line driver and the first power source for supplying voltage to the scan line driver directly on the display-area-including glass substrate and mounts, on the same glass substrate, the IC chip in which the second power source for supplying voltage to the signal line driver is integrated according to a low-withstanding-voltage manufacturing process. With this configuration, the liquid crystal display of the first aspect is small and low in cost.

For the liquid crystal display of the first aspect, a second aspect of the present invention includes, in the first power source directly formed on the display-area-including glass substrate, a voltage converter to convert a voltage supplied from the second power source integrated in the IC chip into a voltage to be supplied to the scan line driver.

According to the second aspect, the first power source directly formed on the display-area-including glass substrate includes a voltage converter to convert a voltage supplied from the second power source integrated in the IC chip into a voltage to be supplied to the scan line driver. With this configuration, the liquid crystal display of the second aspect is small and low in cost, and in addition, has no need for arranging a separate power source to supply voltage to the scan line driver.

For the liquid crystal display of any one of the first and second aspects, a third aspect of the present invention employs a discharger to discharge a capacitor without using the IC chip, the capacitor stabilizing a voltage to be supplied to the scan line driver.

According to the third aspect, the liquid crystal display further includes the discharger to discharge a capacitor without involving the IC chip, the capacitor stabilizing a voltage to be supplied to the scan line driver. With this configuration, the liquid crystal display of the third aspect is small and low in cost, and in addition, prevents breakage of the IC chip.

For the liquid crystal display of any one of the first to third aspects, a fourth aspect of the present invention allows the second power source integrated in the IC chip to suppress a voltage, which is produced during a process of generating a voltage to be supplied to the signal line driver, to or below a maximum operating voltage of the IC chip determined by a manufacturing process of the IC chip.

According to the fourth aspect, the second power source integrated in the IC chip suppresses a voltage, which is produced during a process of generating a voltage to be supplied to the signal line driver, to or below a maximum operating voltage of the IC chip determined by a manufacturing process of the IC chip. With this configuration, the liquid crystal display of the fourth aspect is small and low in cost.

In this way, the present invention directly forms, on a glass substrate, the scan line driver and first power source to supply voltage to the scan line driver and mounts, on the same glass substrate, the IC chip in which the second power source driver to supply voltage to the signal line driver is integrated according to a low-withstanding-voltage manufacturing process. With this configuration, the liquid crystal display of the present invention is small and low in cost.

### BRIEF DESCRIPTION OF THE DRAWINGS

FIG. 1 is a view showing integrated circuits in a liquid crystal display and a manufacturing method thereof according to a related art;

FIG. 2 is a schematic view showing a liquid crystal display having a signal-line-driving IC 15A according to a related art;

FIG. 3 is a graph showing relationships among the manufacturing process, design rule, and cost of a liquid crystal display;

FIG. 4 is a schematic view showing a liquid crystal display according to an embodiment of the present invention;

FIG. 5 is a view showing voltage conversion carried out in the liquid crystal display of the embodiment of FIG. 4;

FIG. 6 is a view showing a circuit arrangement of a signal-line-driving IC 15 shown in FIG. 5 and a method of manufacturing the same;

FIG. 7A is a view showing a problem that occurs when a capacitor C for stabilizing a DC voltage YGVDD is discharged to the signal-line-driving IC 15;

FIG. 7B is a view showing a solution for the problem of FIG. 7A;

FIG. 8 is a view showing a problem that occurs when a DC voltage VDD is simply doubled and tripled in the signal-line-driving IC 15; and

FIG. 9 is a view showing the operation of a DC voltage converter 1508 and voltage stabilizer 1509 to solve the problem of FIG. 8.

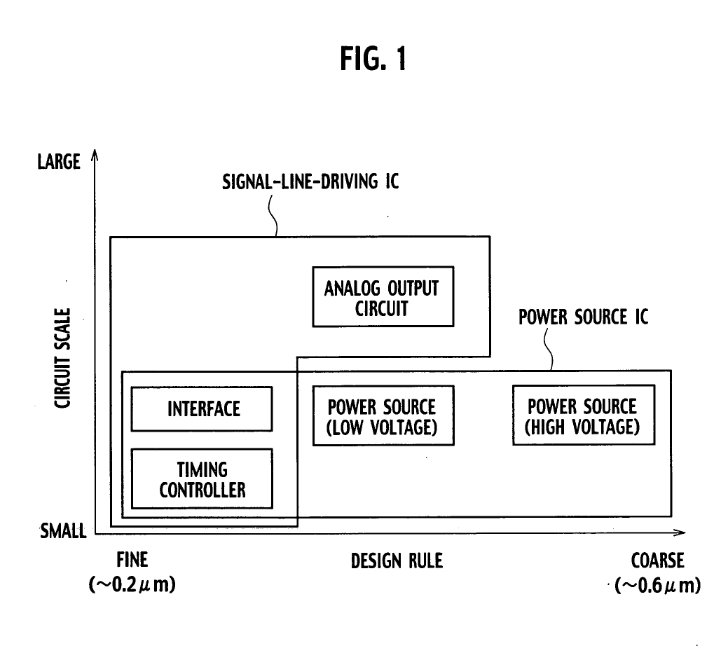

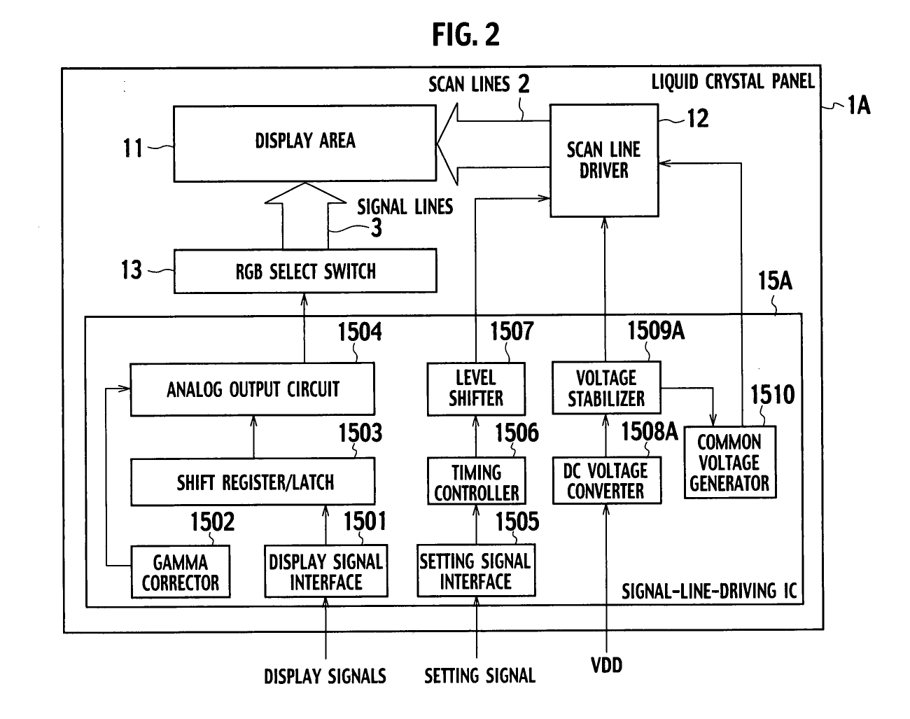

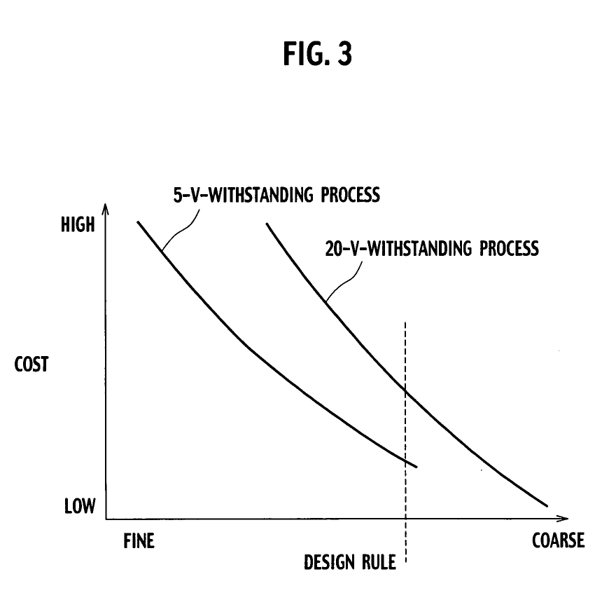

### DETAILED DESCRIPTION OF EMBODIMENTS

An embodiment of the present invention will be explained with reference to the accompanying drawings.

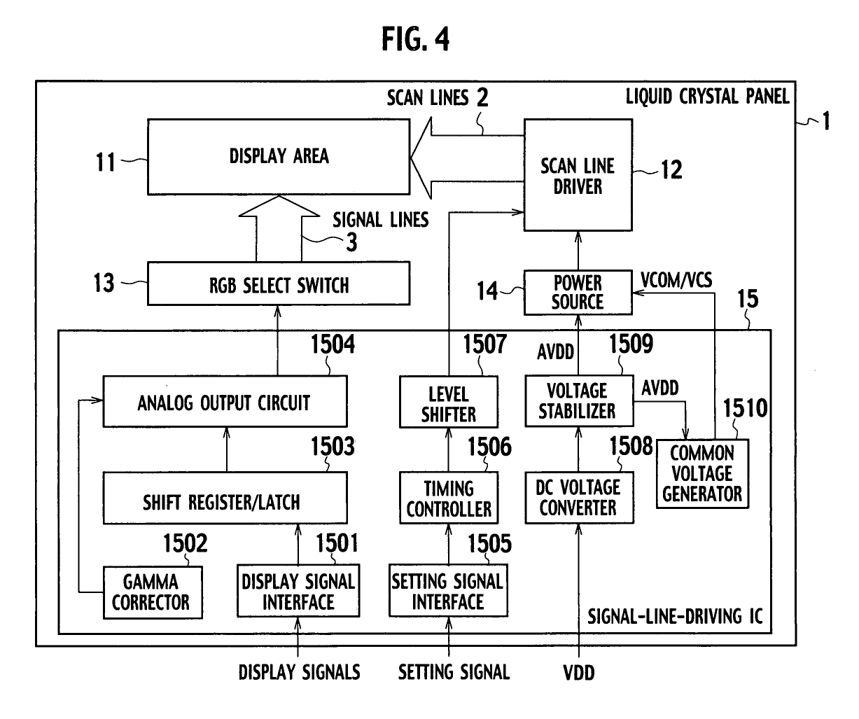

FIG. 4 is a schematic view showing a liquid crystal display according to an embodiment of the present invention. A liquid crystal panel 1 includes an array substrate made of glass, a counter substrate made of glass and facing the array substrate, and a liquid crystal layer arranged between the array substrate and the counter substrate. The liquid crystal panel 1 is, for example, a-Si (amorphous silicon) type or p-Si (polysilicon) type.

On the array substrate, Y scan lines 2 and X signal lines 3 intersect each other. At each intersection of the scan lines 2 and the signal lines 3, a pixel is formed. The scan lines 2, the signal lines 3 and the pixels are in a display area 11. Directly formed on the array substrate are a scan line driver 12 to drive the scan lines 2, an RGB select switch 13 to properly select signal lines 3 according to colors (RGB) to display, and a power source 14 to generate high and negative voltages used to drive the scan line driver 12. Mounted on the array substrate such as COG is a signal-line-driving IC 15 (IC chip) that is externally prepared. The signal-line-driving IC 15 includes a signal line driver to drive the signal lines and is manufactured according to a low-withstanding-voltage (for example, 5 V) process. The counter substrate of the liquid crystal panel 1 has a counter electrode that faces pixel electrodes formed on the array substrate. On the back of the counter electrode, there is a backlight serving as a light source.

In the display area 11, three kinds of pixels, i.e., R (red), G (green), and B (blue) pixels are regularly arranged. Each pixel has a switching element and a pixel electrode. The switching element may be a TFT (thin film transistor) of MOS structure. In this case, a control terminal, i.e., a gate terminal of the TFT is connected to a scan line 2, a voltage supply terminal, i.e., a source terminal of the TFT is connected to a signal line 3, and a drain terminal of the TFT is connected to the pixel electrode (not shown).

The signal-line-driving IC 15 receives, via FPCs (flexible printed circuits, not shown) connected to the liquid crystal panel 1, a DC voltage VDD (+2.4 V to +3.3 V), display signals (video signal (RGB signal), synchronizing signal, and clock signal), and a setting signal. The signal-line-driving IC 15 includes a display signal interface 1501 to receive the display signals, a gamma corrector 1502 to carry out gamma correction, a shift register/latch 1503 to process the display signals, and an analog output circuit 1504 to supply a signal from the shift register/latch 1503 to the RGB select switch 13. These components are integrated to form the signal line driver.

The signal-line-driving IC 15 also includes a setting signal interface 1505 to receive the setting signal, a timing controller 1506 to adjust the timing of the setting signal, and a level shifter 1507 to shift the level of a signal from the timing controller 1506 and supply the level-shifted signal to the scan line driver 12. The power source 14 receives a DC voltage AVDD (+5 V) from a voltage stabilizer 1509 incorporated in the signal-line-driving IC 15 and a common voltage VCOM/VCS from a common voltage generator 1510 incorporated in the IC 15.

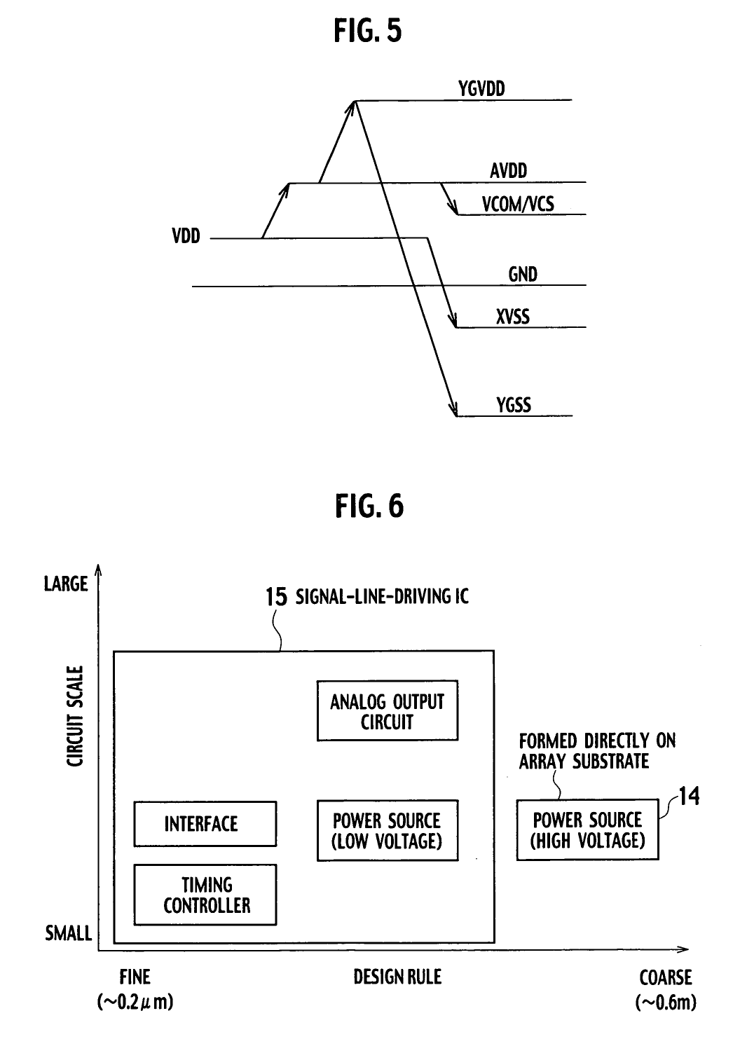

FIG. 5 is a view showing voltage conversion carried out in the liquid crystal display according to the embodiment. In FIG. 5, the DC voltage VDD is converted into a DC voltage AVDD, a DC voltage YGVDD, and a DC voltage XVSS. The DC voltage AVDD is converted into the DC common voltage VCOM/VCS. The DC voltage YGVDD is converted into a DC voltage YGSS. To achieve the voltage conversion shown in FIG. 5, the signal-line-driving IC 15 includes a DC voltage converter 1508 to convert the DC voltage VDD into a voltage not exceeding +5.5 V, the voltage stabilizer 1509 to drop and stabilize the converted voltage to the AVDD (+5 V), and the common voltage generator 1510 to drop and stabilize the DC voltage AVDD (+5 V) to the DC common voltage VCOM/VCS. These components are integrated in the IC 15. The DC voltage AVDD (+5 V) is supplied to the signal line driver and the like contained in the IC 15, to drive them. The power source 14 includes a voltage converter (not shown) to increase the DC voltage AVDD (+5 V) to the DC voltage YGVDD, a voltage converter (not shown) to convert the DC voltage AVDD (+5 V) into the DC voltage XVSS, and a voltage converter (not shown) to convert the DC voltage YGVDD into a DC voltage YGVSS. The converted voltages are supplied to the scan line driver 12 to drive the same.

FIG. 6 is a view showing a circuit arrangement of the signal-line-driving IC 15 of FIG. 5 and a method of manufacturing the same. As shown in FIG. 6, the power source 14 that generates high voltages (and negative voltages) required only by the scan line driver 12 is directly formed on the array substrate of the liquid crystal panel 1. On the other hand, the analog output circuit (1504) forming the signal line driver for driving the signal lines of the liquid crystal panel 1, the interfaces (1501, 1505) to receive external signals, the timing controller (1506), and the low-voltage power source (the DC voltage converter 1508, voltage stabilizer 1509, and common voltage generator 1510) are integrated in the signal-line-driving IC 15.

As shown in FIG. 6, the embodiment directly forms the power source 14 on the array substrate, and therefore, the signal-line-driving IC 15 can positively employ fine design rules to reduce the size of the IC 15.

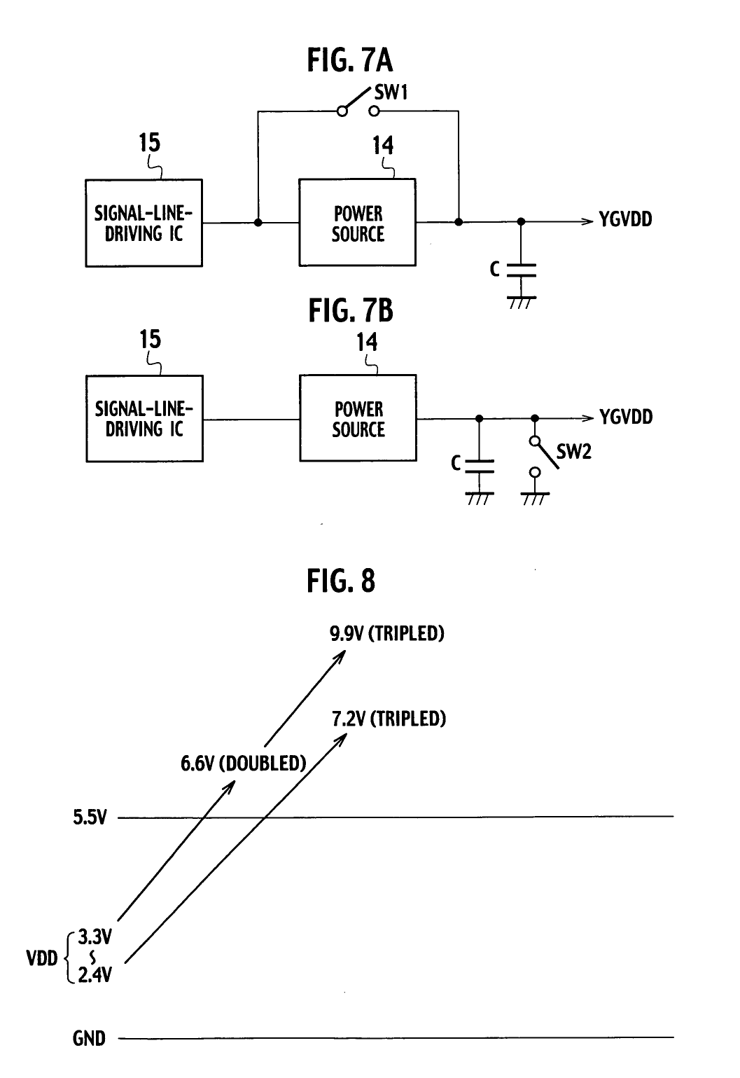

FIG. 7A is a view showing a problem that occurs when a capacitor C for stabilizing the DC voltage YGVDD is discharged via the signal-line-driving IC 15, and FIG. 7B is a view showing a solution for the problem. In FIG. 7A, a switch SW1 is arranged in parallel with the power source 14. When stopping the liquid crystal display, the switch SW1 is closed so that the capacitor C for stabilizing the DC voltage YGVDD is discharged via the signal-line-driving IC 15. At this time, the DC voltage YGVDD is applied to the IC 15, and therefore, the IC 15 must be manufactured according to a highly-withstandable-voltage process. If the IC 15 is manufactured according to a low-withstanding-voltage process, the IC 15 will be broken by the high DC voltage YGVDD. In FIG. 7B, a switch SW2 is arranged in parallel with the capacitor C. When stopping the liquid crystal display, the switch SW2 is closed to discharge the capacitor C. At this time, the DC voltage YGVDD is not applied to the signal-line-driving IC 15, and therefore, the IC 15 can be manufactured according to a low-withstanding-voltage process. Even so, the IC 15 has no risk of breakage. Capacitors for stabilizing the negative DC voltages XVSS and YGSS may also have parallel switches so that the negative voltages are not applied to the signal-line-driving IC 15.

FIG. 8 is a view showing a problem that occurs when the DC voltage VDD is simply doubled and tripled in the signal-line-driving IC 15. A maximum operating voltage of the signal-line-driving IC 15 is determined according to a manufacturing process thereof. If the IC 15 is manufactured based on a low-withstanding-voltage process like this embodiment, the maximum operating voltage of the IC 15 is, for example, +5.5 V. If the DC voltage VDD (+2.4 V to +3.3 V) is simply doubled or tripled in the IC 15, the resultant voltage will sometimes exceed the maximum operating voltage.

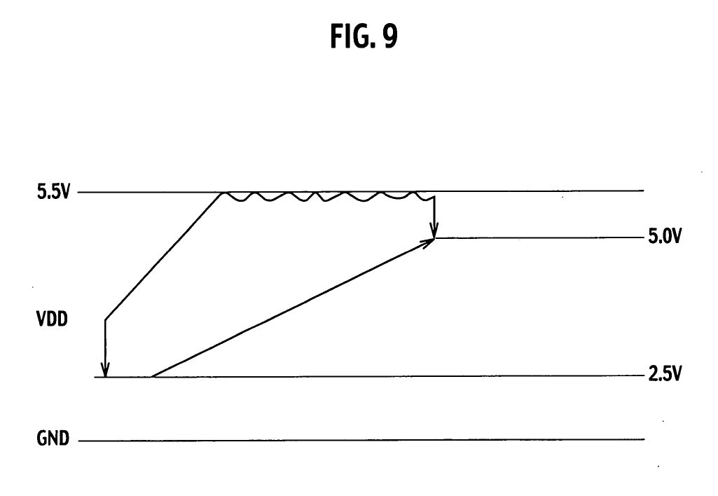

FIG. 9 is a view showing operation of the DC voltage converter 1508 and voltage stabilizer 1509 according to the present invention to solve the problem of FIG. 8. First, the DC voltage converter 1508 steps up the DC voltage VDD (+2.4 V to +3.3 V). When the voltage reaches +5.5 V, the step-up operation is stopped to drop the voltage from +5.5 V. When the voltage drops to, for example, +5.2 V, the step-up operation is resumed. Such operation is repeated to convert the DC voltage VDD (+2.4 V to +3.3 V) into a voltage not exceeding +5.5 V. The voltage stabilizer 1509 drops and stabilizes the converted voltage to the DC voltage AVDD (+5 V). Alternatively, as shown in FIG. 9, the DC voltage VDD (+2.4 V to +3.3 V) may be dropped to and stabilized at, for example, 2.5 V, and then increased to the DC voltage AVDD (+5 V).

In the liquid crystal display according to the present invention, the scan line driver 12 sequentially supplies a scan signal to the scan lines 2. At the same time, the analog output circuit 1504 supplies video signals to the RGB select switch 13, which properly selects the video signals and supplies the selected signals to the signal lines 3. In the display area 11, switching elements that receive the scan signal are turned on, and through the turned-on switching elements, the selected video signals are supplied to the pixel electrodes. Then, electric fields are produced between the pixel electrodes and the counter electrode, to drive liquid crystals. The voltage levels of the supplied video signals change the light transmittance of the liquid crystals in transmitting light from the backlight, to display an image on the display area 11.

As explained above, the present invention directly forms, on an array substrate, the scan line driver 12 to drive scan lines 2 and the power supply circuit 14 to supply voltage to the scan line driver 12 and mounts, on the same array substrate, the signal-line-driving IC 15 (IC chip) in which the power source (the DC voltage converter 1508 and voltage stabilizer 1509) to supply voltage to the signal line driver (the analog output circuit 1504 and the like) is integrated according to a low-withstanding-voltage manufacturing process. With this configuration, the liquid crystal display of the present invention is small and low in cost. It is preferable to manufacture the IC chip 15 based on a five-volt-withstanding manufacturing process.

The power source 14 is provided with voltage converters to convert a voltage supplied from the power source integrated in the signal-line-driving IC 15 into voltages to be supplied to the scan line driver 12. With this configuration, the liquid crystal display of the present invention is small and low in cost. In addition, there is no need of arranging separate power sources to supply voltages to the scan line driver 12.

The capacitor for stabilizing a voltage to be supplied to the scan line driver 12 is discharged through a discharger switch without passing through the signal-line-driving IC 15. With this arrangement, the liquid crystal display of the present invention is small and low in cost, and in addition, prevents breakage of the IC 15 (IC chip).

The power source integrated in the signal-line-driving IC 15 suppresses a voltage, which is generated during a process of generating a voltage to be supplied to the signal line driver, lower than a maximum operating voltage of the IC 15 that is determined by a manufacturing process of the IC 15. With this arrangement, the liquid crystal display of the present invention is small and low in cost.

1. A liquid crystal display having a liquid crystal panel composed of two glass substrates facing each other and liquid crystals held between the two glass substrates, one of the two glass substrates including a display area in which scan lines, signal lines, and pixels are formed, the scan lines and signal lines intersecting each other, the pixels being formed at the intersections of the scan and signal lines, respectively, the liquid crystal display comprising:
a scan line driver to drive the scan lines and a first power source to supply voltage to the scan line driver, the scan line driver and first power source being formed directly on the display-area-including glass substrate; and
an IC (integrated circuit) chip mounted on the display-area-including glass substrate, the IC chip incorporating a second power source integrated in the IC chip according to a low-withstanding-voltage manufacturing process, the second power source supplying voltage to a signal line driver to drive the signal lines.

2. The liquid crystal display of claim 1, wherein:
the first power source directly formed on the display-area-including glass substrate includes a voltage converter to convert a voltage supplied from the second power source integrated in the IC chip into a voltage to be supplied to the scan line driver.

3. The liquid crystal display of any one of claims 1 and 2, further comprising:
a discharger to discharge a capacitor without involving the IC chip, the capacitor serving to stabilize a voltage to be supplied to the scan line driver.

4. The liquid crystal display of any one of claims 1 to 3, wherein:
the second power source integrated in the IC chip suppresses a voltage, which is produced during a process of generating a voltage to be supplied to the signal line driver, to or below a maximum operating voltage of the IC chip determined by a manufacturing process of the IC chip.
